(19) United States
(12) Patent Application Publication
(10) Pub. No.: US 2024/0377877 A1
(43) Pub. Date: Nov. 14, 2024

(54) POWER MANAGEMENT AT HEAD-MOUNTED DEVICE AND A STORAGE CASE

(71) Applicant: Apple Inc., Cupertino, CA (US)

(72) Inventors: Darshan R. KASAR, San Francisco, CA (US); Samuel A. RESNICK, San Francisco, CA (US)

(21) Appl. No.: 18/689,398

(22) PCT Filed: Sep. 8, 2022
(86) PCT No.: PCT/US2022/042951

§ 371 Date: Mar. 5, 2024

Related U.S. Application Data
(60) Provisional application No. 63/246,736, filed on Sep. 21, 2021.

(51) Int. Cl. G06F 1/3234; G02B 27/01; G06F 1/16; G06F 1/3218

(52) U.S. Cl. CPC G06F 1/3265; G02B 27/0172; G06F 1/1628; G06F 1/163; G06F 1/1656; G06F 1/1677; G06F 1/3218

(57) ABSTRACT

A wearable electronic device can interact with a charging case to maintain appropriate power-consumption states while readily transitioning to other states in anticipation of user operation. As the wearable electronic device is accessed from the case, the wearable electronic device can transition to an active state earlier than if the wearable electronic device were to detect the user before transitioning to the active state. In the active state, the wearable electronic device can perform one or more of a variety of actions that are not performed in the sleep state or the off state. For example, by initiating a transition to an active state before the user dons the wearable electronic device, the displays can be ready to output the view earlier so that the user does not spend any or a substantial amount of time being unable to see or waiting for the displays to become active.

### CROSS-REFERENCE TO RELATED APPLICATION

This application claims the benefit of U.S. Provisional Application No. 63/246,736, entitled “POWER MANAGEMENT FOR HEAD-MOUNTABLE DEVICES,” filed Sep. 21, 2021, the entirety of which is incorporated herein by reference.

### TECHNICAL FIELD

The present description relates generally to head-mountable devices, and, more particularly, to power management for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a perspective view of a head-mountable device and case for receiving the head-mountable device, according to some embodiments of the present disclosure.

FIG. 3 illustrates a schematic side view of a head-mountable device and a case in an open configuration, according to some embodiments of the present disclosure.

FIG. 4 illustrates a schematic side view of the head-mountable device and the case of FIG. 3 with the case in a closed configuration, according to some embodiments of the present disclosure.

FIG. 5 illustrates a schematic side view of the head-mountable device and the case of FIG. 4 with the case in a closed configuration, according to some embodiments of the present disclosure.

FIG. 6 illustrates a schematic side view of the head-mountable device and the case of FIG. 5, according to some embodiments of the present disclosure.

FIG. 7 illustrates a view of the head-mountable device of FIG. 6 on a user, according to some embodiments of the present disclosure.

FIG. 8 illustrates a schematic side view of a head-mountable device and a case in a closed configuration, according to some embodiments of the present disclosure.

FIG. 9 illustrates a flow chart for a process having operations performed by a head-mountable device, according to some embodiments of the present disclosure.

FIG. 10 illustrates a view of a head-mountable device on a case, according to some embodiments of the present disclosure.

FIG. 11 illustrates a view of the head-mountable device of FIG. 10 on a user, according to some embodiments of the present disclosure.

FIG. 12 illustrates a view of the head-mountable device of FIG. 10 on a user, according to some embodiments of the present disclosure.

FIG. 13 illustrates a flow chart for a process having operations performed by a head-mountable device, according to some embodiments of the present disclosure.

FIG. 14 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

To conserve power, a head-mountable device can also have multiple operational states that provide functionality when desired and reduces activity when such functions are not needed. However, the transition from a low power state to a fully active state may require an amount of time, in which the user may be required to wait for full activity to be achieved.

Head-mountable devices of the present disclosure can interact with a charging case to maintain appropriate power-consumption states while readily transitioning to other states in anticipation of user operation. As the head-mountable device is accessed from the case, the case and the head-mountable device can interact with each other to transition to an active state of the head-mountable device earlier than if the head-mountable device were to detect the user before transitioning to the active state. In the active state, the head-mountable device can perform one or more of a variety of actions that are not performed in the sleep state or the off state. For example, components of a head-mountable device can include one or more cameras that capture images and/or displays that provide images as views (e.g., to an external environment). In an active state, the head-mountable device can operate the displays to output an image based on a view captured by the cameras. Accordingly, the user wearing the head-mountable device can observe a view of their environment. By initiating a transition to an active state before the user dons the head-mountable device, the displays can be ready to output the view earlier so that the user does not spend any or a substantial amount of time being unable to see or waiting for the displays to become active.

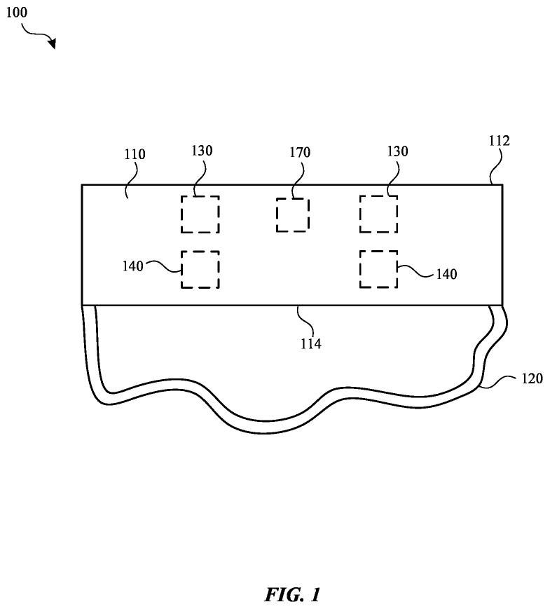

These and other embodiments are discussed below with reference to FIGS. 1-14. However, those skilled in the art will readily appreciate that the detailed description given herein with respect to these Figures is for explanatory purposes only and should not be construed as limiting.

According to some embodiments, for example as shown in FIG. 1, a head-mountable device 100 can include a housing 110 that is worn on a head of a user. The housing 110 can be positioned in front of the eyes of a user to provide information within a field of view of the user.

The housing 110 can be supported on a user's head with the head engager 120. The head engager 120 can wrap or extend along opposing sides of a user's head. The head engager 120 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head. The head engager 120 can extend from the housing 110. The housing can provide nose pads or another feature to rest on a user's nose.

While the housing 110 is shown schematically with a particular size and shape, it will be understood that the size and shape of the housing 110, particularly at the inner side 114 of the housing 110, can have a size and shape that accommodates the face of a user wearing the head-mountable device 100. As used herein, an inner side 114 of a portion of a head-mountable device is a side that faces toward the user and/or away from the external environment. For example, the inner side 114 can provide a shape that generally matches the contours of the user's face around the eyes of the user. The inner side can be provided with one or more features that conform to the face of the user to enhance comfort and block light from an external environment. For example, the inner side 114 can provide a flexible, soft, elastic, and/or compliant structure.

The housing 110 can provide structure around a peripheral region thereof to support any internal components of the housing 110 in their assembled position. For example, the housing 110 can enclose and support various internal components (including for example integrated circuit chips, processors, memory devices and other circuitry) to provide computing and functional operations for the head-mountable device 100, as discussed further herein. While several components are shown within the housing 110, it will be understood that some or all of these components can be located anywhere within or on the head-mountable device 100. For example, one or more of these components can be positioned within the head engager 120 of the head-mountable device 100.

The housing 110 can include and/or support one or more cameras 130. The cameras 130 can be positioned on or near an outer side 112 of the housing 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the housing 110. A display 140 can transmit light from a physical environment (e.g., as captured by a camera) and/or views captured by the cameras 130 for viewing by the user. Such a display 140 can include optical properties, such as lenses for vision correction based on incoming light from the cameras and/or the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

Each display 140 can be adjusted to align with a corresponding eye of the user. For example, each display 140 can be moved along one or more axes until a center of each display 140 is aligned with a center of the corresponding eye. Accordingly, the distance between the displays 140 can be set based on an interpupillary distance of the user. IPD is defined as the distance between the centers of the pupils of a user's eyes.

The head-mountable device 100 can include a sensor 170. The sensor 170 can be positioned and arranged to detect a characteristic of the user, such as facial features. For example, the sensor 170 can detect whether a user is wearing the head-mountable device 100. In such an embodiment, the sensor 170 can include an optical sensor (e.g., a camera), a depth sensor, a proximity sensor, a thermal (e.g., infrared) sensor, and the like. By further example, a sensor 170 can perform facial feature detection, facial movement detection, facial recognition, eye tracking, pupil measurements, user mood detection, user emotion detection, voice detection, and the like. Operational states of the head-mountable device 100 can be selected based, at least in part, on detections performed by the sensor 170, as described further herein.

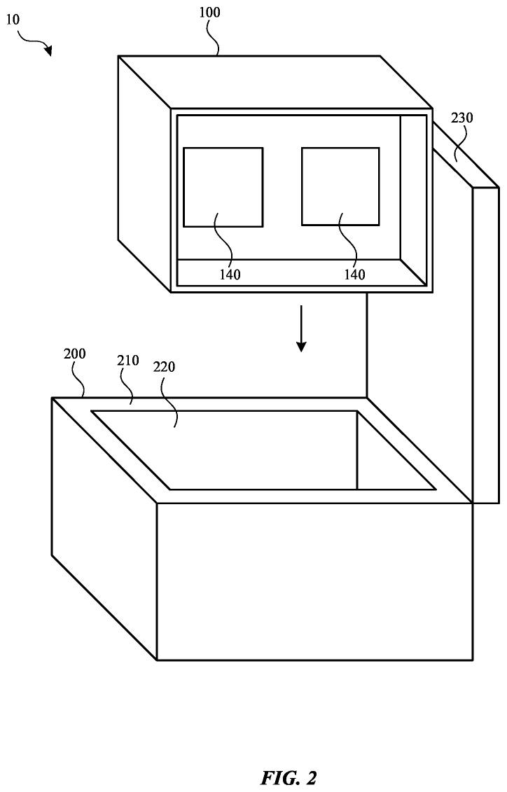

Referring now to FIGS. 2-7, a case can be provided for receiving the head-mountable device and for storage, transport, charging, and/or one or more other interactions with the head-mountable device.

As shown in FIG. 2, a head-mountable device 100 and a case 200 can, together, form a system 10 in which the head-mountable device 100 and a case 200 interact with each other. The case 200 can include a chamber 220 for receiving at least a portion of the head-mountable device 100. For example, the head-mountable device 100 can be inserted into the chamber 220 and secured therein at least temporarily. The case 200 can serve as a storage container for holding the head-mountable device 100 while not in use. The case 200 can further serve as a charging station for charging a battery of the head-mountable device 100.

The case 200 can include a base 210 and a lid 230. The lid 230 can transition and/or be transitioned between an open configuration and a closed configuration. While in the open configuration, the lid 230 can provide access to the chamber 220 for insertion and/or removal of the head-mountable device 100. While in the closed configuration, the lid 230 can cover the chamber 220. For example, the base 210 and the lid 230, while in the closed configuration, can partially or entirely surround the head-mountable device 100 while it is within the chamber 220.

Optionally, the chamber 220 can provide a size and/or shape that corresponds to a size and/or shape of at least a portion of the head-mountable device 100. As such, the head-mountable device 100 can be directed to a particular position and/or orientation within the chamber 220. Additionally or alternatively, the head-mountable device 100 and/or the case 200 can include engagement elements (e.g., magnets, snaps, guides, rails, and the like) to guide and maintain the head-mountable device 100 in a particular position and/or orientation with respect to the case 200. For example, the housing 110 of the head mountable device 100 can be at least partially rigid such that it can be engaged by the case 200 in a known and predictable position and orientation with respect to the case 200 and its components.

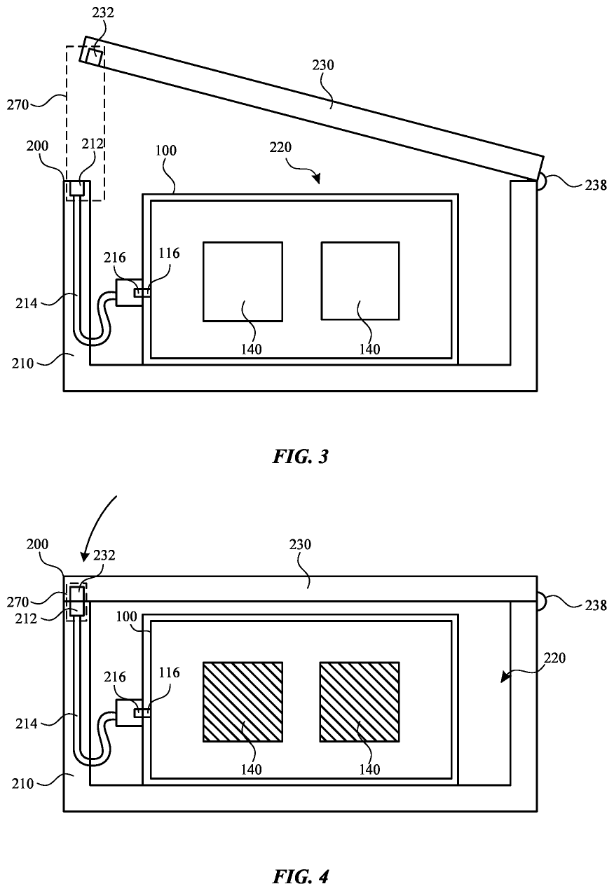

As shown in FIG. 3, the head-mountable device 100 can be placed within the chamber 220 of the case 200. Access for placement and/or insertion of the head-mountable device 100 can be provided while the lid 230 of the case 200 is in an open configuration. In the illustrated embodiment, the lid 230 is rotatably attached to the base 210 by a hinge 238. It will be understood that other arrangements are contemplated, such as a lid 230 that slides and are otherwise releasable he attaches to the base 210. By further example, multiple lids and/or lid portions can be provided.

As further shown in FIG. 3, the case 200 can include a case communication interface 216 that operably connects to an HMD communication interface 116 of the head-mountable device 100. While the head-mountable device 100 is connected to the case 200, for example via the case communication interface 216 and the HMD communication interface 116, the head-mountable device 100 and the case 200 can communicate and/or transfer power there between. For example, a power source of the case 200 can supply power to the head-mountable device 100 via the case communication interface 216 and the HMD communication interface 116. By further example, components (e.g., processors, sensors, etc.) of the case 200 can communicate with components of the head-mountable device 100 via the case communication interface 216 and the HMD communication interface 116. The case communication interface 216 and the HMD communication interface 116 can be releasably yet securely coupled together, for example with magnets, latches, locks, detents, snaps, buttons, and the like. Optionally, the case communication interface 216 and the HMD communication interface 116 can engage each other automatically when the head-mountable device 100 is placed within the case 200. Alternatively, the case communication interface 216 and the HMD communication interface 116 can engage each other when manually connected by user.

The head-mountable device 100 may be placed into the case 200 while the head-mountable device 100 is an active state. Optionally, the head-mountable device 100 can detect when it is no longer being warned by user, for example with a sensor thereof, and change from its active state to another state (e.g., sleep state or off state, as described further herein). Additionally or alternatively, the head-mountable device 100 may maintain its active state until certain interactions occur with respect to the case 200. For example, the head-mountable device 100 may detect when it is operably connected to the case 200 (e.g., via the case communication interface 216 and the HMD communication interface 116) and change to a different state.

The case 200 can provide mechanisms by which the configuration of the lid 230 can be detected. For example, the lid 230 can include a lid detector 270 that detects whether the lid 230 is open or closed. The lid detector 270 can include multiple interacting components distributed in both the lid 230 and the base 210. For example, the lid detector 270 can include a detectable feature 232 in the lid 230 and a base sensor 212 in the base 210. The sensor(s) and detectable feature(s) can include components that interact with each other differently depending on the configuration of the lid 230 with respect to the base 210. For example, the detectable feature 232 can include a magnet, and the base sensor 212 can include a Hall effect sensor, a magnetometer, and/or another sensor for detecting the magnet (i.e., as the detectable feature 232). It will be understood that a variety of other sensors and detectable features can be provided. For example, the base sensor 212 can include a proximity sensor, a depth sensor, and the like to directly detect the position of the lid 230 with respect to the base 210. By further example, the base sensor 212 can include a switch (e.g., electromechanical switch) that is activated and deactivated based on the position of the lid 230 with respect to the base 210. It will be further understood that only one of the detectable feature 232 and the base sensor 212 may be provided, and/or that multiple detectable features 232 and/or multiple base sensors 212 can be provided. It will be further understood that, the position of the sensor and detectable feature can be exchanged, such that the lid can contain the sensor and the base can contain the detectable feature. Where both are provided, either one of the lid component and/or the base component can detect the other.

As further shown in FIG. 3, the base sensor 212 can be operably connected to the case communication interface 216 by a connector 214. As such, the case 200 can communicate to the head-mountable device 100 any detected configuration of the lid 230 with respect to the base 210. Additionally or alternatively, the lid component 232 can be operably connected to the head-mountable device 100.

As shown in FIG. 4, the lid 230 can be transitioned to the close configuration to enclose the head-mountable device 100 within the chamber 220 of the case 200. As the lid 230 transitions between the open configuration and the closed configuration, the detectable feature 232 and the base sensor 212 can interact and/or detect that the lid 230 has been closed. Such a detection can be communicated to the head-mountable device 100 via the case communication interface 216 and the HMD communication interface 116.

In response to a detection that the lid 230 has been closed, the head-mountable device 100 can change its operational state, for example to conserve power. In some embodiments, the head-mountable device 100 can change from an active state to a sleep state while within the case 200 and while the lid 230 is closed.

As used herein, an “active state” is an operational state in which the head-mountable device 100 provides power to systems for operation while being worn by a user. Such systems can include processors, memory, cameras, displays, sensors, and the like.

As used herein, an “off state” is an operational state in which the head-mountable device 100 does not provide power to some or all of its components, such as processors, memory, cameras, displays, sensors, and the like. For example, the processor(s) may have no software in its main memory while in an off state. During reboot from an off state (i.e., to an active state), software must be loaded into memory before it can be executed, for example, by hardware or firmware. During a reboot or while entering an off state, memory (e.g., RAM) can be cleared while it has no power provided thereto.

As used herein, a “sleep state” is a low power operational state of the head-mountable device in which electrical consumption is lower compared to the active state. A sleep state can be referred to as standby, suspend, and/or suspend to RAM. While in a sleep state, the state of the head-mountable device 100 is held in memory (e.g., RAM) and the head-mountable device 100 otherwise reduces or cuts power to at least some components. The memory (e.g., RAM) can be placed into a minimum power state sufficient to retain its data. The head-mountable device 100 can wake from the sleep state to resume the active state. By waking from the sleep state, rather than rebooting from the off state, the head-mountable device 100 allows the user to avoid having to reissue instructions or to wait for a machine to fully reboot. Accordingly, the time required to wake from a sleep state is shorter than the time required for reboot from an off state. In some embodiments, the sleep state can include maintaining activity of certain components while reducing or cutting activity of others, as described further herein.

While the head-mountable device 100 can initially be placed in a sleep state when the lid 230 is closed, other steps can be taken while the lid 230 remains closed. For example, if the head-mountable device 100 remains within the case 200 with the lid 230 closed or an amount of time that exceeds a threshold, then the head-mountable device 100 can shut down to an off state. By further example, such action can be taken based on a charge level of the head-mountable device 100 and/or other detected condition relating to the head-mountable device 100 and/or the case 200.

As shown in FIG. 3, the lid 230 of the case 200 can be opened to provide access to the head-mountable device 100 within the chamber 220 of the case 200. When the lid 230 transitions to an open configuration, such a change can be detected, for example, by the detectable feature 232 and/or the base sensor 212. Accordingly, the detection can be communicated to the head-mountable device 100, for example, via the case communication interface 216 and the HMD communication interface 116.

Upon detecting that the lid 230 is opened, the head-mountable device 100 can perform certain operations even before the head-mountable device 100 is removed from the case 200. For example, where the head-mountable device 100 was in a sleep state at the time the lid 230 is opened, the head-mountable device 100 can wake from the sleep state to an active state. By further example, where the head-mountable device 100 was in an off state at the time the lid 230 is opened, the head-mountable device 100 can reboot to an active state.

By responding to the detection that the lid 230 is open, the wake or reboot steps can be initiated earlier than would be possible if the head-mountable device 100 were merely responding to a detection that it is donned by a user or otherwise turned on when the user operates the head-mountable device 100. Accordingly, the head-mountable device 100 can be ready and available for operation by the user at an earlier point in time. Additionally, such actions can be initiated by the case 200, which can have its own power source.

Accordingly, the head-mountable device 100 can maintain its low power-consumption state (e.g., sleep state or off state), rather than maintain operation of systems that would otherwise need to be operable to detect when the user is ready to operate the head-mountable device 100.

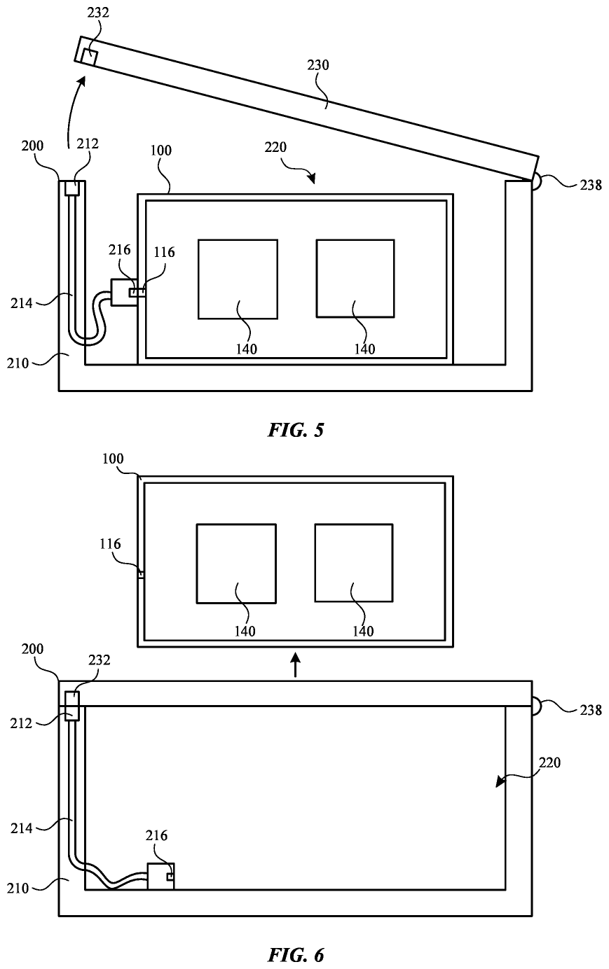

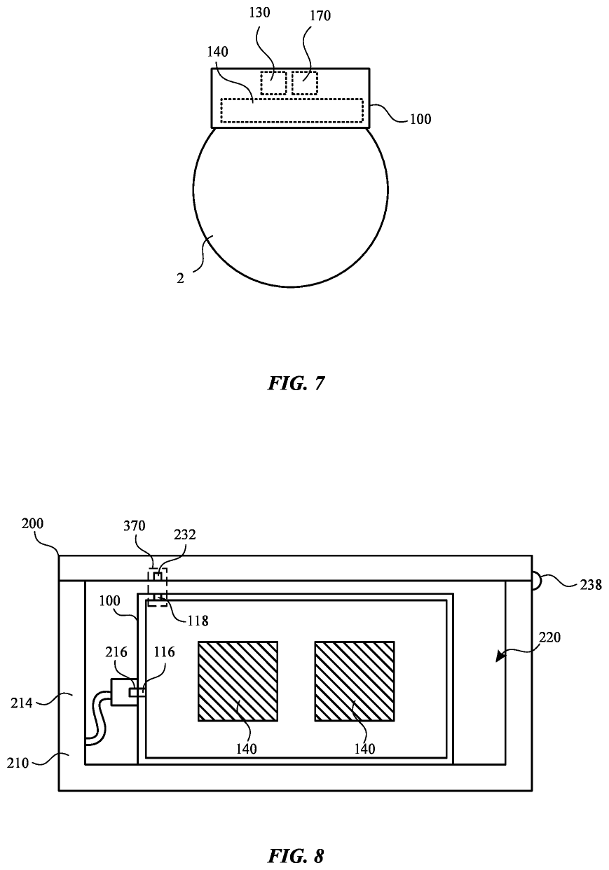

As shown in FIG. 6, the head-mountable device 100 can be disconnected from the case (e.g., the case communication interface 216 from the HMD communication interface 116) and removed from the chamber 220. Thereafter, as shown in FIG. 7, the head-mountable device 100 can be donned on a head of the user 2. The placement of the head-mountable device 100 on the head of the user to can be detected, for example by a sensor 170 of the head-mountable device 100. The display 140 and/or other components of the head-mountable device 100 can be operated to provide outputs to the user 2. However, it will be understood that such an active state of operation can be initiated and/or achieved prior to donning the head-mountable device 100 on the head of the user 2 and/or prior to removal of the head-mountable device 100 from the case 200.

In the active state, the head-mountable device can perform one or more of a variety of actions that are not performed in the sleep state or the off state. For example, in an active state, the head-mountable device can operate the displays to output an image based on a view captured by the cameras. Accordingly, the user wearing the head-mountable device can observe a view of their environment. By initiating a transition to an active state before the user dons the head-mountable device, the displays can be ready to output the view earlier so that the user does not spend any or a substantial amount of time being unable to see or waiting for the displays to become active.

Referring now to FIG. 8, a head-mountable device can directly detect the configuration of the case and/or its lid. As shown in FIG. 8, a lid detector 370 can include multiple interacting components distributed in both the lid 230 and the head-mountable device 100. For example, the lid detector 370 can include a detectable feature 232 in the lid 230 and an HMD sensor 118 in the head-mountable device 100. The sensor(s) and detectable feature(s) can include components that interact with each other differently depending on the configuration of the lid 230 with respect to the head-mountable device 100. For example, the detectable feature 232 can include a magnet, and the HMD sensor 118 can include a Hall effect sensor, a magnetometer, and/or another sensor for detecting the magnet of the detectable feature 232. It will be understood that a variety of other sensors can be provided. For example, the detectable feature 232 and/or the HMD sensor 118 can include a proximity sensor, a depth sensor, and the like to directly detect the position of the lid 230 with respect to the head-mountable device 100. By further example, the detectable feature 232 and/or the HMD sensor 118 can include a switch (e.g., electromechanical switch) that is activated and deactivated based on the position of the lid 230 with respect to the head-mountable device 100. It will be further understood that only one of the detectable feature 232 and the HMD sensor 118 may be provided, and/or that multiple detectable features 232 and/or multiple base sensors 212 can be provided. It will be further understood that, the position of the sensor and detectable feature can be exchanged, such that the lid can contain the sensor and the head-mountable device 100 can contain the detectable feature. Where both are provided, either one of the lid component and/or the HMD component can detect the other.

The head-mountable device 100 need not be operably connected to a sensor of the base 210. Nonetheless, as further shown in FIG. 8, the head-mountable device 100 can be operably connected to the case 200 via the case communication interface 216 and the HMD communication interface 116 for charging and/or other communication.

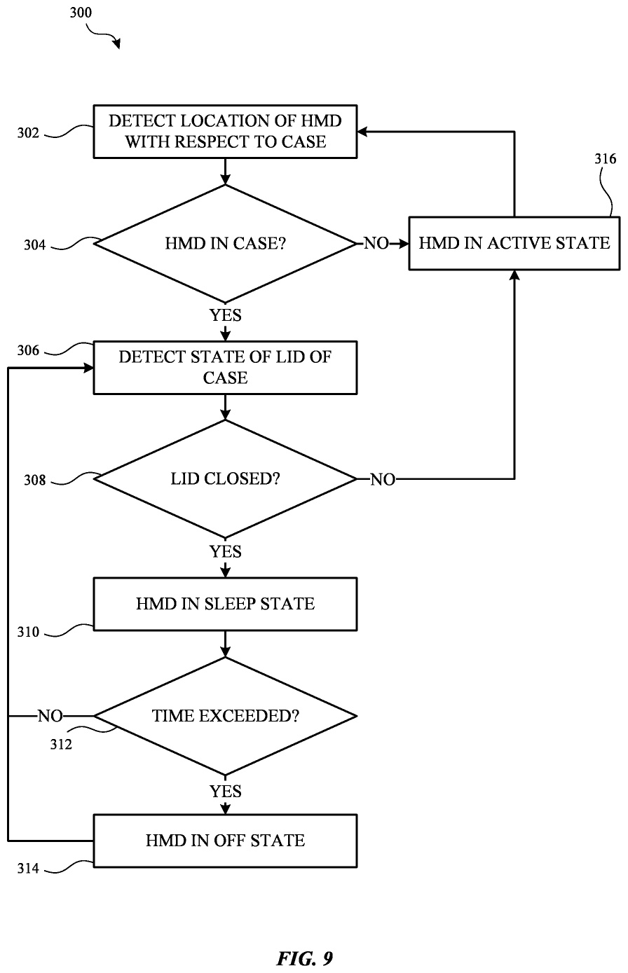

FIG. 9 illustrates a flow diagram of an example process 300 for managing a power state of a head-mountable device. For explanatory purposes, the process 300 is primarily described herein with reference to the head-mountable device 100 and case 200 of FIGS. 1-8. However, the process 300 is not limited to the head-mountable device 100 and case 200 of FIGS. 1-8, and one or more blocks (or operations) of the process 300 may be performed by different components of the head-mountable device, the case, and/or one or more other devices. Further for explanatory purposes, the blocks of the process 300 are described herein as occurring in serial, or linearly. However, multiple blocks of the process 300 may occur in parallel. In addition, the blocks of the process 300 need not be performed in the order shown and/or one or more blocks of the process 300 need not be performed and/or can be replaced by other operations.

The process 300 can begin when the head-mountable device detects a location thereof with respect to a case (302). For example, a head-mountable device can determine whether it is inside or outside of a case. Such a detection can be based on whether the head-mountable device is operably and/or mechanically connected to the case with communication interfaces, as described herein. By further example, a head-mountable device can communicate with the case to determine its relationship thereto.

The head-mountable device can determine whether it is within a case (304). If the head-mountable device is determined to be not within a case and/or in use or being worn by a user, then the head-mountable device can enter or maintain an active state thereof, as described herein (316). The determination of whether a head-mountable device is within a case can include determinations of conditions that would preclude and/or confirm the condition of being within a case. For example, if a head-mountable device is determined to be worn by a user (e.g., with an eye sensor), than the head-mountable device can further be determined to not be within a case. By further example, detection of the location of the head-mountable device with respect to a case can be initiated if and/or only if the head-mountable device is first determined to not be currently worn and/or used by a user.

The head-mountable device can further detect the state of the lid of the case (306). For example, the case can perform a detection regarding the state of the lid and communicate a corresponding signal as an indicator of the state of the lid to the head-mountable device via one or more interfaces there between. By further example, the head-mountable device can directly perform a detection regarding the state of the lid, thereby not requiring communication with the case.

The head-mountable device can determine whether the lid is closed (308). If the lid of the case is determined to be closed, then the head-mountable device can enter or maintain a sleep state thereof, as described herein (310). If the lid is determined to be open, then the head-mountable device can enter or maintain an active state thereof, as described herein (316).

The head-mountable device can determine whether a time threshold has been exceeded (312). If the time threshold has been exceeded, then the head-mountable device can enter or maintain an off state thereof, as described herein (314). If the time threshold has not been exceeded, then the head-mountable device can enter or maintain the sleep state and perform further detections, as described herein (306).

While the head-mountable device is in an off state, it can be configured to reboot upon a detection that the lid has been opened and/or that the head-mountable device has been removed from the case. Such actions can be prompted by a signal from the case, so that the head-mountable device can maintain its components in a low-power or no-power state. Accordingly, the head-mountable device can remain responsive to the opening of the lid and/or the removal of the head-mountable device from the case.

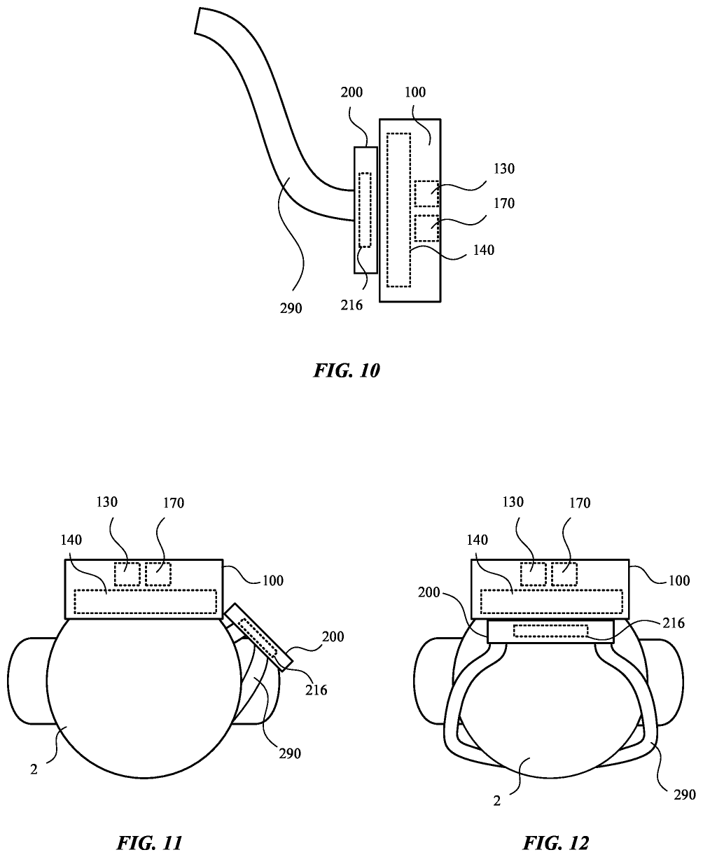

Referring now to FIGS. 10 and 11, a head-mountable device can be used with a case to transition between different operating states of the head-mountable device. As shown in FIG. 10, a case 200 can provide a mechanism for transporting the head-mountable device 100. For example, the case 200 can be a wearable device into which the head-mountable device 100 can be placed while not worn by a user. By further example, the case 200 can include a case engager 290, such as a strap, handle, band, or other mechanism for being held by or securing to a user and/or another device. In such an example, the case 200 can provide power for charging the head-mountable device while remaining mobile and portable.

It will be understood that the case 200 need not fully enclose or surround the head-mountable device 100 while coupled thereto. For example, the case 200 can releasably secure itself to the head-mountable device on a side thereof. This can help the head-mountable device be more readily available for the user when desired.

The head-mountable device 100 can communicate with the case 200 to determine its relationship thereto. Such communication be with the case communication interface 216, such as by radio-frequency identification (RFID) by using electromagnetic fields to automatically identify and track tags attached to the case. For example, the case and/or the head-mountable device can include a radio transponder, a radio receiver, and/or a radio transmitter. When the head-mountable device is brought into proximity of (e.g., coupled to) a case, it can detect an RFID tag thereof to determine its location with respect to the case.

As shown in FIG. 11, when the head-mountable device 100 is brought to the face and/or head of the user 2, the head-mountable device 100 can transition to an active state. When the head-mountable device 100 is removed from the case 200 and/or otherwise brought to the face of the user 2, the sensor 170 can detect or confirm that the user is wearing the head-mountable device 100. Accordingly, the head-mountable device 100 can operate in an active state. In some embodiments, operating in the active state includes operating the display 140 to output an image captured by the camera 130. It will be understood that a variety of other operations are also contemplated while in the active state.

Optionally, as shown in FIG. 12, the head-mountable device 100 can transition to an active state while remaining coupled to the case 200. For example, the case 200 can move up to the face of the user 2 along with the head-mountable device 100 as the user holds the head-mountable device 100 to the face. This can allow the user to perform certain actions (e.g., observe environment, receive information, capture images with a camera, etc.) without requiring full donning of the head-mountable device 100 and/or decoupling from the case 200.

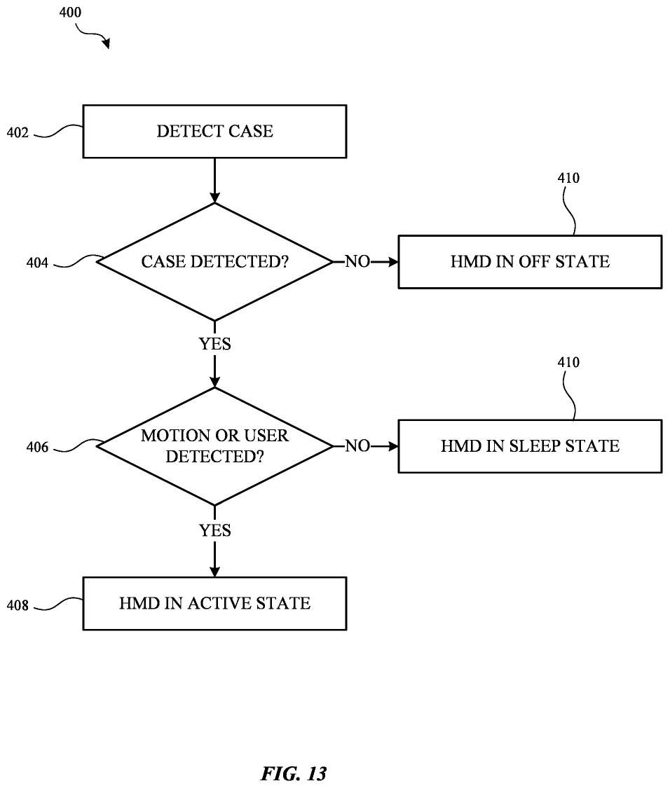

FIG. 13 illustrates a flow diagram of an example process 400 for managing a power state of a head-mountable device. For explanatory purposes, the process 400 is primarily described herein with reference to the head-mountable device 100 and case 200 of FIGS. 10 and 11. However, the process 400 is not limited to the head-mountable device 100 and case 200 of FIGS. 10-12, and one or more blocks (or operations) of the process 400 may be performed by different components of the head-mountable device, the case, and/or one or more other devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The process 400 can begin when the head-mountable device detects whether a case is nearby (402). For example, a head-mountable device can determine whether a signal can be detected from a case. By further example, a detection can be based on whether the head-mountable device is operably and/or mechanically connected to a case with communication interfaces, as described herein. By further example, a head-mountable device can communicate with the case to determine its relationship thereto. Such communication can include radio-frequency identification (RFID) by using electromagnetic fields to automatically identify and track tags attached to the case. For example, the case and/or the head-mountable device can include a radio transponder, a radio receiver, and/or a radio transmitter. When the head-mountable device is brought into proximity of (e.g., placed within) a case, it can detect an RFID tag thereof to determine its location with respect to the case.

For example, the head-mountable device can determine an identity of the case, for example based on an RFID tag of the case. Associated actions can be determined based on the identity of the case. For example, each case can have an action associated with it, wherein the action is to be performed by the head-mountable device when the head-mountable device is within a proximity of the case. Once the action is determined, the action can be performed by the head-mountable device. In some embodiments, the action can include entering or maintaining a sleep state of the head-mountable device when certain conditions are met.

If the head-mountable device detects a case (404), then the head-mountable device can determine further interactions based on whether there is an indication that the user may operate the head-mountable device. If the head-mountable device detects that no case is present, then the head-mountable device can enter or maintain an off state. Alternatively, the head-mountable device may maintain any other state, including an active state is currently worn by the user.

If the head-mountable device detects motion and/or that a user is wearing the head-mountable device (406), then the head-mountable device can enter or maintain an active state thereof, as described herein (408). For example, the head-mountable device can transition to an active state based on movement thereof, for example is detected by an accelerometer, gyroscope, and the like. By further example, the head-mountable device can transition to an active state based on a detection that the head-mountable device is being worn by a user. Combinations of detections can further result in a transition to an active state. For example, movement of the head-mountable device can prompt further detections, such as verification of a case and/or detecting whether a user is wearing the head-mountable device. Subsequent actions can be taken based on the results of such detections, as described herein.

If the head-mountable device detects a case and does not detect other conditions, such as motion above a threshold amount and/or a user wearing the head-mountable device, then the head-mountable device can enter or maintain a sleep state (410).

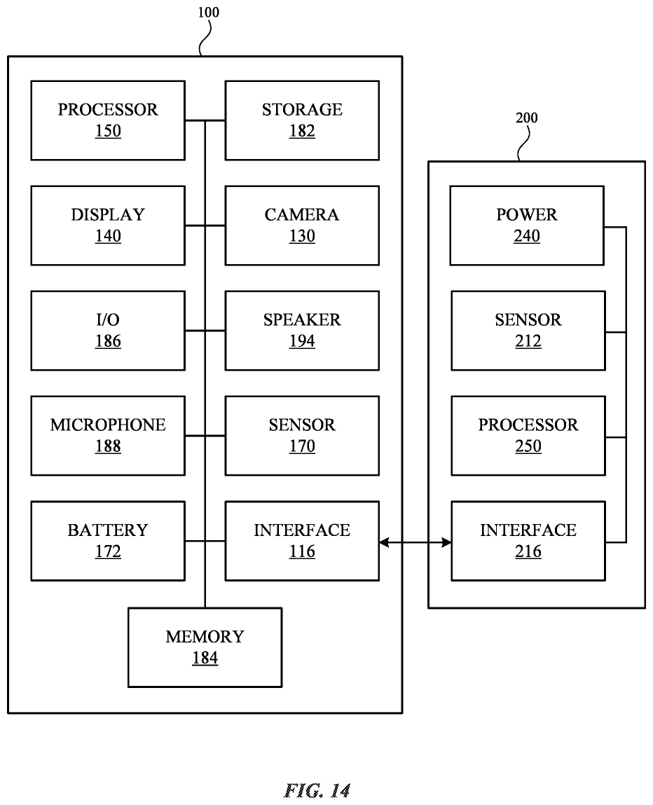

Referring now to FIG. 14, components of the head-mountable device can be operably connected to provide the performance described herein. FIG. 14 shows a simplified block diagram of an illustrative head-mountable device 100 in accordance with one embodiment of the invention. It will be appreciated that components described herein can be provided on one, some, or all of a frame and/or a head engager. It will be understood that additional components, different components, or fewer components than those illustrated may be utilized within the scope of the subject disclosure.

As shown in FIG. 14, the head-mountable device 100 can include a processor 150 (e.g., control circuitry) with one or more processing units that include or are configured to access a storage 182 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The storage 182 can store electronic data that can be used by the head-mountable device 100. For example, the storage 182 can store electrical data or content such as, for example, audio and video files, documents and applications, device settings and user preferences, timing and control signals or data for the various modules, data structures or databases, and so on. The storage 182 can be configured as any type of memory. By way of example only, the storage 182 can be implemented as random access memory, read-only memory, Flash memory, removable memory, or other types of storage elements, or combinations of such devices.

Like the storage 182, a memory 184 may be a read-and-write memory device. However, unlike the storage 182, the memory 184 may be a volatile read-and-write memory, such as random access memory (“RAM”). The memory 184 may store any of the instructions and data that the processor 150 may need at runtime. In one or more implementations, the processes of the subject disclosure are stored in the memory 184 and/or the storage 182. From these various memory units, the processor 150 retrieves instructions to execute and data to process in order to execute the processes of one or more implementations.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can further include a camera 130 for capturing a view of an external environment, as described herein. The view captured by the camera can be presented by the display 140 or otherwise analyzed to provide a basis for an output on the display 140.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 194 can be operably connected to the processor 150 for control of speaker output, including sound levels, as described further herein.

The head-mountable device 100 can include one or more sensors 170 that are operable to measure characteristics of the user and/or the head-mountable device 100, as described herein. The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 130 which can capture image-based content of the outside world.

The head-mountable device 100 can include a battery 172, which can charge and/or power components of the head-mountable device 100. The battery can receive power from external devices connected to the head-mountable device 100, such as the case 200.

The head-mountable device 100 can include an HMD communication interface 116 for communicating with one or more servers or other devices, such as the case 200, using any suitable communications protocol. For example, the HMD communication interface 116 can support Wi-Fi (e.g., a 802.11 protocol), Ethernet, Bluetooth, high frequency systems (e.g., 900 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. The HMD communication interface 116 can also include an antenna for transmitting and receiving electromagnetic signals.

The case 200 can be operated to provide power from a power source 240 to the head-mountable device 100 (e.g., to charge the battery 172). The power source 240 can include an adapter that is connectable to another power source that is external to the case 200, such as an AC power source. Additionally or alternatively, the power source 240 can include a battery that provides power even when the case 200 is not connected to another power source that is external to the case 200. Such a configuration would allow the power source 240 to provide power while the case 200 is portable.

The case 200 can include a processor 250 (e.g., control circuitry) with one or more processing units that include or are configured to access a memory having instructions stored thereon. The instructions or computer programs may be configured to perform one or more of the operations or functions described with respect to the case 200. The processor 250 can be implemented as any electronic device capable of processing, receiving, or transmitting data or instructions. For example, the processor 250 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The case 200 can include a case communication interface 216 for communicating with one or more servers or other devices, such as the head-mountable device 100, using any suitable communications protocol. For example, the case communication interface 216 can support Wi-Fi (e.g., a 802.11 protocol), Ethernet, Bluetooth, high frequency systems (e.g., 900 MHZ, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. The case communication interface 216 can also include an antenna for transmitting and receiving electromagnetic signals. The case communication interface 216 can be used for both communication and/or power transfer between the head-mountable device and the case 200.

Accordingly, embodiments of the present disclosure provide a head-mountable device that can interact with a charging case to maintain appropriate power-consumption states while readily transitioning to other states in anticipation of user operation. As the head-mountable device is accessed from the case, the case and the head-mountable device can interact with each other to transition to an active state of the head-mountable device earlier than if the head-mountable device were to detect the user before transitioning to the active state. In the active state, the head-mountable device can perform one or more of a variety of actions that are not performed in the sleep state or the off state. For example, in an active state, the head-mountable device can operate the displays to output an image based on a view captured by the cameras. Accordingly, the user wearing the head-mountable device can observe a view of their environment. By initiating a transition to an active state before the user dons the head-mountable device, the displays can be ready to output the view earlier so that the user does not spend any or a substantial amount of time being unable to see or waiting for the displays to become active.

Various examples of aspects of the disclosure are described below as clauses for convenience. These are provided as examples, and do not limit the subject technology.

Clause A: a head-mountable device comprising; an HMD communication interface configured to engage a case communication interface to receive power from a case; and a processor configured to; receive from the case an indicator of whether a lid of the case is open or closed; when the lid is closed and the head-mountable device is within the case, maintain the head-mountable device in a sleep state; and when the lid is open, maintain the head-mountable device in an active state.

Clause B: a case comprising; a base defining a chamber for receiving a head-mountable device; a lid configured to provide access to the chamber when open; and a lid detector configured to detect whether the lid is open or closed; and a case communication interface for operably connecting to the head-mountable device, the case communication interface being configured to; when the lid is closed and the head-mountable device is within the case, transmit a first signal including an instruction to the head-mountable device to be in a sleep state; and when the lid is open, transmit a second signal including an instruction to the head-mountable device to be in an active state.

Clause C: a system comprising; a case comprising; a power source; a case communication interface configured to provide an identification of the case; a head-mountable device comprising; an HMD communication interface configured to receive the identification of the case; a sensor configured to detect when the head-mountable device is moved from the case to a face of a user; a processor configured to; while the head-mountable device is coupled to the case, operate the sensor with the head-mountable device in a sleep state; and when the head-mountable device is moved to the face of the user, wake the head-mountable device from the sleep state to an active state.

One or more of the above clauses can include one or more of the features described below. It is noted that any of the following clauses may be combined in any combination with each other, and placed into a respective independent clause, e.g., clause A, B, or C.

Clause 1: in the sleep state, a state of the head-mountable device is stored in memory and the processor of the head-mountable device does not receive power; and in the active state, the state of the head-mountable device is retrieved from the memory and the processor of the head-mountable device receives power.

Clause 2: the processor is further configured to; when the lid is closed and the head-mountable device is within the case, disable the camera and the display; and when the lid is open, operate the display to output the view.

Clause 3: a sensor configured to detect when a user is wearing the head-mountable device, wherein the processor is further configured to operate the sensor when the lid is open.

Clause 4: the processor is further configured to disable the sensor when the lid is closed and the head-mountable device is within the case.

Clause 5: a battery, wherein the processor is further configured to charge the battery with power received from the case when the lid is closed and the head-mountable device is within the case.

Clause 6: an HMD sensor, wherein the indicator comprises a feature of the lid that is detectable by the HMD sensor.

Clause 7: the HMD sensor comprises a Hall effect sensor configured to detect a magnet of the lid.

Clause 8: a microphone; and a speaker, wherein the processor is further configured to disable the microphone and the speaker when the lid is closed and the head-mountable device is within the case.

Clause 9: the lid detector comprises; a detectable feature in the lid; and a base sensor in the base.

Clause 10: the detectable feature comprises a magnet; and the base sensor comprises a Hall effect sensor.

Clause 11: the head-mountable device further comprises a sensor configured to detect when a user is wearing the head-mountable device, wherein; the first signal further includes an instruction to disable the sensor; and the second signal further includes an instruction to operate the sensor.

Clause 12: the head-mountable device further comprises; a camera configured to capture a view; and a display configured to output the view, wherein; the first signal further includes an instruction to disable the camera and the display; and the second signal further includes an instruction to operate the display to output the view.

Clause 13: the HMD communication interface is configured to read an RFID tag of the case to receive the identification of the case.

Clause 14: the head-mountable device further comprises; a camera configured to capture a view; and a display configured to output the view, wherein the processor is configured to, when the head-mountable device is moved to the face of the user, operate the display to output the view.

Clause 15: the head-mountable device further comprises an accelerometer configured to detect when the head-mountable device is moved to the face of the user.

Clause 16: the head-mountable device further comprises an eye sensor configured to detect when the head-mountable device is moved to the face of the user.

Clause 17: the case comprises a case engager for securing the case to the user.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary housing of reference, rather than to the ordinary gravitational housing of reference. Thus, such a term may extend upwardly, downwardly, diagonally, or horizontally in a gravitational housing of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
an HMD communication interface configured to engage a case communication interface to receive power from a case; and
a processor configured to:
receive from the case an indicator of whether a lid of the case is open or closed;
when the lid is closed and the head-mountable device is within the case, maintain the head-mountable device in a sleep state; and
when the lid is open, maintain the head-mountable device in an active state.

2. The head-mountable device of claim 1, wherein:
in the sleep state, a condition of the head-mountable device is stored in memory and the processor of the head-mountable device does not receive power; and
in the active state, the condition of the head-mountable device is retrieved from the memory and the processor of the head-mountable device receives power.

3. The head-mountable device of claim 1, further comprising:
a camera configured to capture a view; and
a display configured to output the view, wherein the processor is further configured to:
when the lid is closed and the head-mountable device is within the case, disable the camera and the display; and
when the lid is open, operate the display to output the view.

4. The head-mountable device of claim 1, wherein the processor is further configured to determine that the head-mountable device is within the case when the HMD communication interface is engaged to the case communication interface.

5. The head-mountable device of claim 1, further comprising a sensor configured to detect when the head-mountable device is worn, wherein the processor is further configured to operate the sensor when the lid is open, wherein the processor is further configured to disable the sensor when the lid is closed and the head-mountable device is within the case.

6. The head-mountable device of claim 1, further comprising a battery, wherein the processor is further configured to charge the battery with power received from the case when the lid is closed and the head-mountable device is within the case.

7. The head-mountable device of claim 1, further comprising an HMD sensor, wherein the lid comprises a feature that is detectable by the HMD sensor.

8. The head-mountable device of claim 7, wherein the HMD sensor comprises a Hall effect sensor, and the feature comprises a magnet, the Hall effect sensor being configured to detect the magnet of the lid.

9. The head-mountable device of claim 1, further comprising:
a microphone; and
a speaker, wherein the processor is further configured to disable the microphone and the speaker when the lid is closed and the head-mountable device is within the case.

10. A case comprising:
a base defining a chamber for receiving a head-mountable device;
a lid configured to provide access to the chamber when open;
a lid detector configured to detect whether the lid is open or closed; and
a case communication interface for operably connecting to the head-mountable device, the case communication interface being configured to:
when the lid is closed and the head-mountable device is within the case, transmit a first signal including an instruction to the head-mountable device to enter a sleep state; and
when the lid is open, transmit a second signal including an instruction to the head-mountable device to enter an active state.

11. The case of claim 10, wherein the lid detector comprises:
a detectable feature in the lid; and
a base sensor in the base configured to detect the detectable feature.

12. The case of claim 11, wherein:
the detectable feature comprises a magnet; and
the base sensor comprises a Hall effect sensor.

13. The case of claim 10, wherein the head-mountable device further comprises a sensor configured to detect when the head-mountable device is worn, wherein:
the first signal further includes an instruction to disable the sensor; and
the second signal further includes an instruction to operate the sensor.

14. The case of claim 10, wherein the head-mountable device further comprises:
a camera configured to capture a view; and
a display configured to output the view, wherein:
the first signal further includes an instruction to disable the camera and the display; and
the second signal further includes an instruction to operate the display to output the view.

15. A system comprising:
a case comprising:
a power source; and
a case communication interface configured to provide an identification of the case; and
a head-mountable device comprising:
an HMD communication interface configured to receive the identification of the case;
a sensor configured to detect when the head-mountable device is moved from the case to a face; and
a processor configured to:
while the head-mountable device is coupled to the case, operate the sensor with the head-mountable device in a sleep state; and
when the head-mountable device is moved to the face, wake the head-mountable device from the sleep state to an active state.

16. The system of claim 15, wherein the HMD communication interface is configured to read an RFID tag of the case to receive the identification of the case.

17. The system of claim 15, wherein the head-mountable device further comprises:
a camera configured to capture a view; and
a display configured to output the view, wherein the processor is configured to, when the head-mountable device is moved to the face, operate the display to output the view.

18. The system of claim 15, wherein the head-mountable device further comprises an accelerometer configured to detect when the head-mountable device is moved to the face.

19. The system of claim 15, wherein the head-mountable device further comprises an eye sensor configured to detect when the head-mountable device is moved to the face.

20. The system of claim 15, wherein the case comprises a case strap for carrying the case.
